(19) United States
(12) Patent Application Publication
(10) Pub. No.: US 2017/0316317 A1
(43) Pub. Date: Nov. 2, 2017

(54) Method of Using a Dynamic Agile Process Model to Increase Situational Awareness of a Computer

(71) Applicant: SPAWAR SYSTEMS CENTER PACIFIC, San Diego, CA (US)

(72) Inventors: Jeff Howard Waters, San Diego, CA (US); Bruce David Plutchak, San Diego, CA (US); Eric Walter VonColln, San Diego, CA (US)

(21) Appl. No.: 15/363,206

(22) Filed: Nov. 29, 2016

Related U.S. Application Data
(60) Provisional application No. 62/305,788, filed on Mar. 9, 2016.

(51) Int. Cl. G06N 5/02; G06F 17/30

(52) U.S. Cl. CPC G06N 5/022; G06F 17/30864; G06F 17/30887

(57) ABSTRACT

A computer implemented method comprising: inputting steps of at least two processes into the computer; storing process step input products and process step output products in a shared, non-transitory database as they are generated; establishing an input product filter for each process step with performance-triggering-criteria-defined property/value filters, where one step's output product passes the input product filter of another step; periodically searching the shared database for input products; determining whether each step in any of the processes has been executed, is in the process of being executed, or is awaiting execution; dynamically and automatically assembling or altering a set of steps composing any given process depending on the input products available in the shared database; and comparing the input/output products property values to target property values to automatically assess the status, effectiveness and efficiency of the individual steps and each process as a whole.

### CROSS-REFERENCE TO RELATED APPLICATION

This application claims the benefit of U.S. Provisional Application No. 62/305,788, filed 9 Mar. 2016, titled “Method of Machine Learning via a Dynamic Agile Process Model” (Navy Case #103451).

### FEDERALLY-SPONSORED RESEARCH AND DEVELOPMENT

The United States Government has ownership rights in this invention. Licensing and technical inquiries may be directed to the Office of Research and Technical Applications, Space and Naval Warfare Systems Center, Pacific, Code 72120, San Diego, Calif., 92152; voice (619) 553-5118; ssc_pac_t2@navy.mil. Reference Navy Case Number 103451.

### BACKGROUND OF THE INVENTION

Computers are often used to execute processes (i.e., a series of steps, including sub-steps, representing a method or procedure for accomplishing a goal). Typically, computers have difficulty changing, reusing, realigning processes dynamically, e.g. skipping steps, inserting steps or integrating with other processes, without considerable manual effort to alter the representations.

### SUMMARY

Disclosed herein is a computer-implemented method for providing situational awareness to a computer comprising the following steps. The first step provides for inputting steps of at least two processes into the computer. The next step provides for storing each input product and each output product in a shared, non-transitory database as they are generated. The next step provides for establishing an input product filter for each step. The next step provides for periodically searching the shared database with URL queries for input products. The next step provides for determining with the computer whether each step in any of the processes has been executed, is in the process of being executed, or is awaiting execution. The next step provides for dynamically and automatically assembling or altering a set of steps composing any given process depending on the input products available in the shared database. The next step provides for comparing with a performance status monitoring engine the input/output products property values to the target property values to automatically assess the status, effectiveness and efficiency of the individual steps and of each process as a whole.

Another embodiment of the computer-implemented method for providing situational awareness to a computer may be described as comprising the following steps. The first step provides for identifying a first process and a second process that have an aspect in common. Each of the first and second processes comprises a series of steps and an end goal. The next step provides for identifying an input product comprising performance-triggering criteria for each step in the first and second processes. The next step provides for generating a unique output product at the completion of each step in the first and second processes. The next step provides for storing the output products in a cloud-based, shared database. Each output product and each input product has a unique URL according to a taxonomy. The next step provides for filtering with the computer the output products in the database for every un-executed step by performing URL queries for the input product of each un-executed step. The next step provides for determining that a given step may be executed based on the presence of the given step's input product in the database. The next step provides for determining with the computer a situational assessment based on the interaction of the steps of the first and second processes and evaluating how interaction between the two processes will affect the attainment of the goals.

In another embodiment of the computer-implemented method for providing situational awareness to a computer, the computer may control an avatar and the embodiment of the method may be described as comprising the following steps. The first step provides for identifying at least two processes related to the avatar. The next step provides for identifying an input product comprising performance-triggering criteria for each step in the identified processes. The next step provides for generating a unique output product at the completion of each step in the identified processes. The next step provides for storing the output products in a cloud-based, shared database. Each output product and each input product has a unique URL according to a taxonomy. The next step provides for filtering the output products in the database for every un-executed step by performing URL queries for the input product of each un-executed step. The next step provides for determining with the avatar that a given step may be executed based on the presence of the given step's input product in the database. The next step provides for developing with the avatar a situational assessment based on the interaction of the steps of the identified processes and evaluating how interaction between the processes will affect the attainment of the respective goals.

### BRIEF DESCRIPTION OF THE DRAWINGS

Throughout the several views, like elements are referenced using like references. The elements in the figures are not drawn to scale and some dimensions are exaggerated for clarity.

FIG. 1 is a flowchart of an embodiment of a method for providing situational awareness to a computer.

FIG. 2 is a graphical representation of a method for providing situational awareness to a computer.

FIG. 3 is a flowchart of an embodiment of a method for providing situational awareness to a computer.

FIG. 4 is a graphical representation of process steps linked together through a shared database.

FIG. 5 is a graphical representation of a sample piece of an example product type hierarchy from which a process representation model may be derived.

FIG. 6 is a flowchart of an embodiment of a method for providing situational awareness to a computer.

### DETAILED DESCRIPTION OF EMBODIMENTS

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

Described herein is a method for providing situational awareness to a computer. The disclosed method describes how a computer can be structured in a way that allows it to understand how two or more process interact and/or affect each other—thus achieving a degree of awareness that is similar to a human's “situational awareness”. From a lay perspective, definitions of “situation” include: a set of circumstances in which one finds oneself; a state of affairs of special or critical significance; critical circumstances at a given moment; and position or status with regard to conditions. To some degree, being aware of one's situation is tantamount to being conscious. The method claimed herein enables a computer to achieve a degree of consciousness or self-awareness.

One can identify certain fundamental characteristics of situational awareness, including: (1) a set of facts or opinions; (2) tied together by some common aspect, e.g. location, person, event; (3) relevant for some goal or mission; and (4) of some significance. For example, if a person is in a car accident, the person's “situation” might include the condition of the people in the car, the car itself, the degree of injury, the location, and the need for help or services. These are a set of facts or opinions, tied together by the person and the event (the accident), relevant for the person's ongoing goal of continued health and the health of the other passengers, the continuance of the person's journey, and significant for getting the person and car up and running again. Other facts such as what the person is wearing, type of damage to the pavement, and/or the time of day may be considered irrelevant to the person, at least with respect to the current car accident situation. However, those same facts, while not being part of the person's “situation” they may be relevant if the “situation” is viewed from a different perspective.

Awareness may be defined variously as: knowledge or perception of a situation or fact; feeling, experiencing or noticing something; knowing and understanding a lot about what is happening in the world around you. These definitions imply different degrees of awareness. “Knowledge” of something seems to go beyond perception to include a deeper appreciation or understanding, what one might term situational “assessment”. Assessment may be defined as the evaluation or estimation of the nature, quality or ability of someone or something; the act of making a judgment about something; and the result of judging the worth or value of something. From these considerations, one might extend the characteristics of situation awareness to include: (5) perception of the key facts; (6) from a relevant perspective; and (7) an understanding of the value of or the impact of those facts on one's ability to achieve one's goal. The disclosed method for providing situation awareness to a computer implements a process model that has these same characteristics (numbered 1-7 above) and so effectively provides situational awareness to the computer.

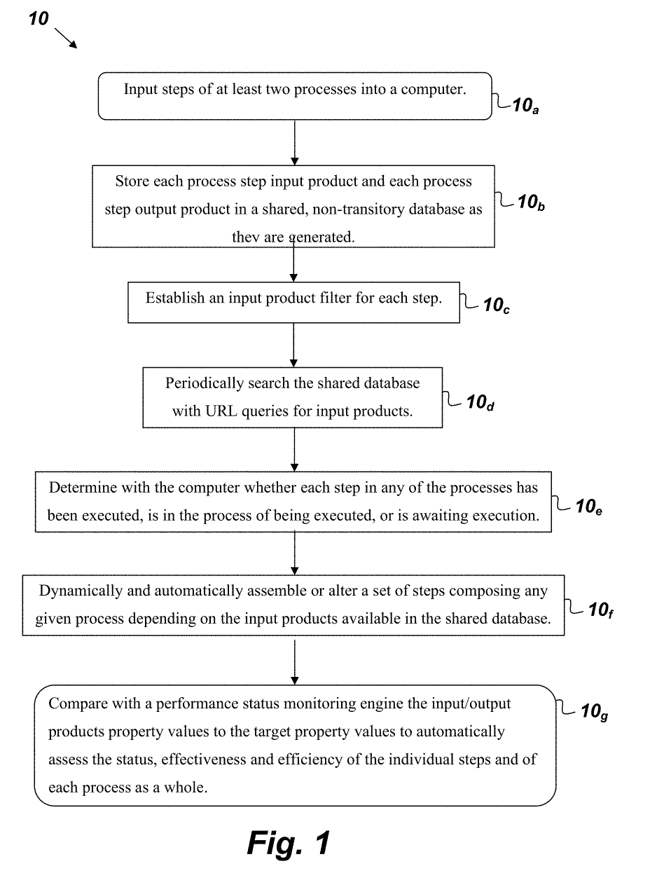

FIG. 1 is a flowchart of an embodiment of a computer implemented method 10 for providing situational awareness to a computer comprising the following steps. Step 10ₐ provides for inputting steps of at least two processes into the computer. As used herein, a “process” is defined as a series of “steps” for accomplishing a goal. A “step” in this setting is a “task”, or an “action”, something someone or something needs to do. For a task to be completed, something needs to have been accomplished, and that accomplishment can be considered an output “product” of the task. Each task may have one or more input or output products. For purposes of method 10, each step corresponds to a set of input products, a task to be completed, a set of output products, and a set of target output products. Each input, output, and target output product, as well as each task, comprises a set of property/value pairs that includes product type and product target values. For example, “choosing a particular course of action” is a task whose inputs are the optional courses of action and whose output product is the selected course of action which might include metadata such as the time the output product was generated. A “target” output product might be a selected course of action generated by a specific time. A comparison of the “target” product time to the output product time could be used as a measure of performance. Also, if this were a training scenario, a preferred course of action could be used as the “target” output product for a performance measure.

The next step 10_{b} provides for storing each input product and each output product in a shared, non-transitory database as they are generated, wherein each input product and each output product is stored with a unique uniform resource locator (URL). The next step 10_{c} provides for establishing an input product filter for each step, wherein the input product filter comprises performance-triggering criteria defined property/value filters, where one step's output product passes the input product filter of another step. The next step 10_{d} provides for periodically searching the shared database with URL queries for input products. The next step 10ₑ provides for determining with the computer whether each step in any of the processes has been executed, is in the process of being executed, or is awaiting execution. The next step 10_{f} provides for dynamically and automatically assembling or altering a set of steps composing any given process depending on the input products available in the shared database. The next step 10_{g} provides for comparing with a performance status monitoring engine the input/output products property values to the target property values to automatically assess the status, effectiveness and efficiency of the individual steps and of each process as a whole.

An embodiment of method 10 may be described as a method for representing and programming dynamic processes such as workflows; this comprises defining output products for each step in the workflow in a progressive, generic, hierarchical, machine-understandable and addressable format and using filters such as URL queries on the product types and properties to define the input for each step. A suitable example of a progressive, generic, hierarchical, machine-understandable and addressable format is, but is not limited to, the java script object notation (JSON) as defined by Ecma International® standard ECMA-404 the JSON Data Interchange Standard, which includes property/values and links to parent/child product types, which may be referred to as linked data. A refined version of the JSON format, JSON-Linked Data (JSON-LD), as defined by the World Wide Web Consortium (W3C) Recommendation 16 Jan. 2014 JSON-LD 1.0: A JSON-based Serialization for Linked Data, provides additional semantic context for even greater machine-understandability. Definitions of the products and the processes can then be utilized in a supporting framework/architecture to enable distributed, decentralized implementations. A suitable example of a supporting framework is, but is not limited to, representational state transfer (REST), or RESTful http-based web architecture, such as is described in a doctoral dissertation by Roy Thomas Fielding titled, “Architectural Styles and the Design of Network-based Software Architectures”, (See Chapter 5: Representational State Transfer (REST) (2000), (Ph.D.), University of California, Irvine.)

This approach, of using the linked data, filters, and progressive formats allows the steps in a given process to be triggered by inputs coming from any other process step, if they pass the filter, thereby enabling new process creation and new process behavior which is dynamic and autonomous. This means that process steps can be skipped and inserted, that processes can self-integrate, and that much greater reuse of processes and subprocesses is possible without hardwiring, recoding and without requiring a costly, brittle, and unscalable orchestrated centralized control.

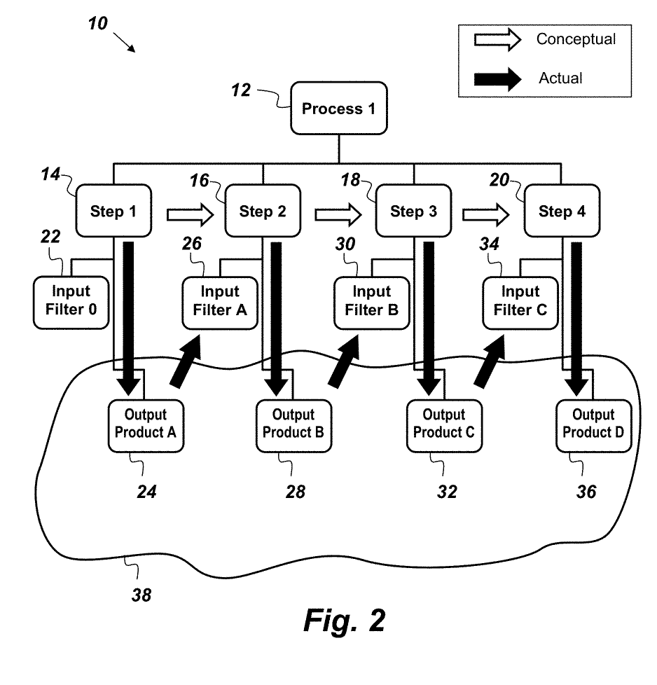

FIG. 2 is a graphical representation of an embodiment of method 10. In this embodiment, a given process 12 comprises a first step 14, a second step 16, a third step 18, and a fourth step 20. The first step 14 includes an input product filter 22 and an output product 24. The second step 16 includes an input product filter 26 and an output product 28. The third step 18 includes an input product filter 30 and an output product 32. The fourth step 20 includes an input product filter 34 and an output product 36. The output products 24, 28, 32, and 36 are stored in a shared database 38. As shown, a given step of the process 12 is triggered when an output product in the shared database 38 passes the input product filter of the given step. The shared database 38 may hold output products from many different processes. Thus, any given step of any given process may be triggered if an output product can be found in the shared database 38 that passes the given step's input product filter regardless of sequence of steps in the given process.

A given step is deemed executed if all of the given step's input products are found in the shared database and all the given step's output products have been generated and stored in the shared database. A given step is awaiting execution if all of the given step's input products are found in the shared database but not all of the given step's output products have been generated. A given step is awaiting execution if all of the given step's input products are not found in the shared database.

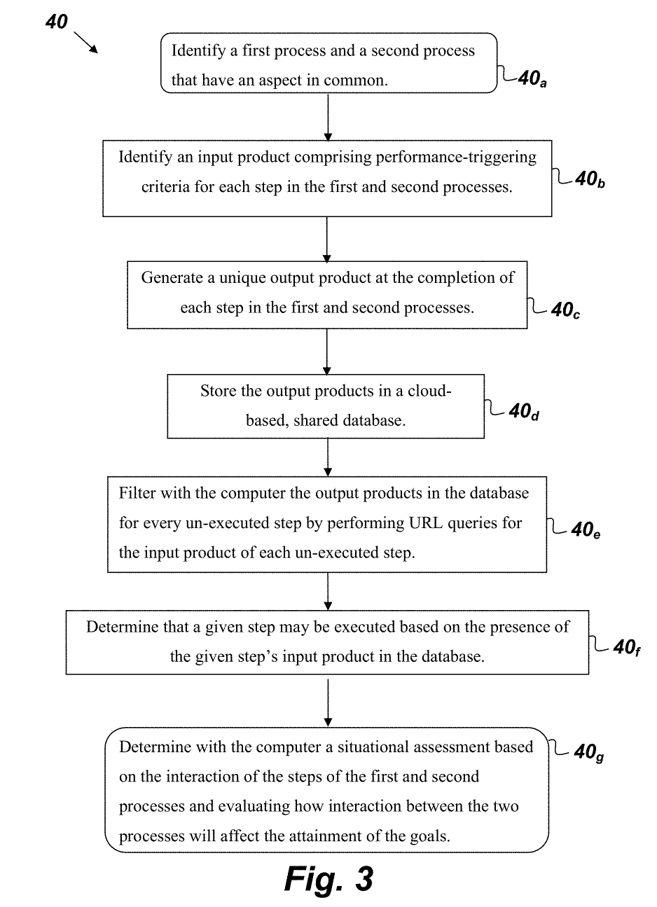

FIG. 3 is a flowchart of an alternate embodiment 40 of the method 10 for providing situational awareness to a computer. Alternate embodiment 40 of method 10 comprises, consists of, or consists essentially of the following steps. The first step 40ₐ provides for identifying a first process and a second process that have an aspect in common. Each of the first and second processes comprises a series of steps and an end goal. The next step 40_{b} provides for identifying an input product comprising performance-triggering criteria for each step in the first and second processes. The next step 40_{c} provides for generating a unique output product at the completion of each step in the first and second processes. The next step 40_{d} provides for storing the output products in a cloud-based, shared database. Each output product and each input product has a unique URL according to a taxonomy. The next step 40ₑ provides for filtering with the computer the output products in the database for every un-executed step by performing URL queries for the input product of each un-executed step. The next step 40_{f} provides for determining that a given step may be executed based on the presence of the given step's input product in the database. The next step 40_{g} provides for determining with the computer a situational assessment based on the interaction of the steps of the first and second processes and evaluating how interaction between the two processes will affect the attainment of the goals.

The lay definition of situational awareness has been refined for different environments. For example, situational awareness in the field of command and control related to aviation may be defined as, “ . . . the perception of the elements in the environment within a volume of time and space, the comprehension of their meaning, and the projection of their status in the near future.” (Endsley, Mica R. “Toward a theory of situation awareness in dynamic systems.” Human Factors: The Journal of the Human Factors and Ergonomics Society 37, no. 1 (1995): 32-64) Such refined, environment-specific definitions of situational awareness are not too different from the lay definition discussed above, but focus a bit more on time aspects: past, present and future relevance of situation awareness. Many of these refined definitions also mention a “mental model of the current state” from the operator's perspective, managing the “streams of incoming data”, and integrating the many complex parts into a presumably simpler integrated whole. In addition to the characteristics of situation awareness numbered 1-7 above, method 10 provides situational awareness to a computer that has the following characteristics: (8) mental model; (9) integrating complex data into a simpler whole; and (10) an appreciation for the past (actions and states of affairs to assist understanding the present situation), present (awareness and understanding of the present situation), and future (impact on remaining steps to reach the goal).

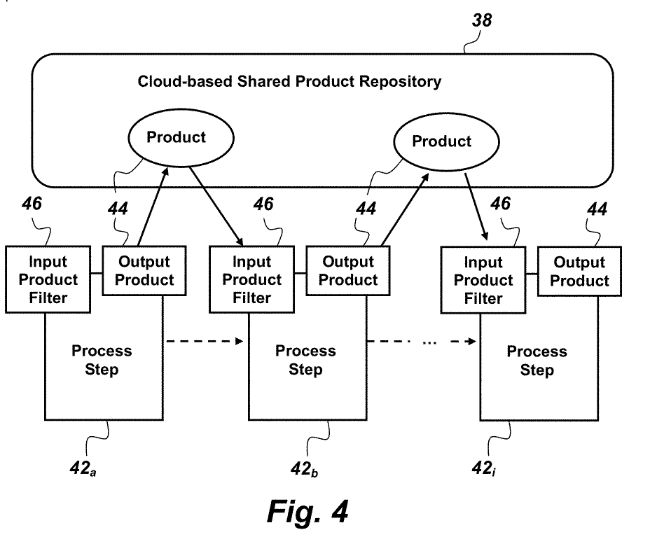

FIG. 4 is a graphical representation of process steps 42ₐ-42ᵢ linked together through the shared database 38. One way to implement method 10 is to provide situational awareness to a computer is through the use of a dynamic agile process model (DAPM). In the case of the DAPM, the steps 42 can be linked via the products 44 (which may be specified by URL) or product filters 46 (which also may be specified by URL), providing a level of abstraction that enables process steps 42 to be linked flexibly, dynamically and autonomously. The products 44 represent interim or final results of an overall process.

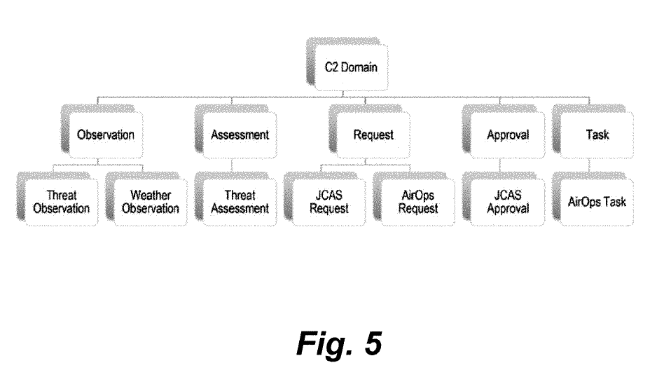

FIG. 5 is a graphical representation of a sample piece of an example product type hierarchy from which a process representation model may be derived. A “process” can be represented as a sequence of steps (such as the steps 42 shown in FIG. 4) where each “step” represents an action that has an input and an output “product”. These process representations (“models”) can be derived from many sources, such as Joint doctrine for best practices for Joint Close Air Support (JCAS), Air Operations, or other activities. FIG. 5 shows a model for command and control (C2) in the JCAS field. With the DAPM, a user can define output products for each step in the workflow in a progressive, generic, hierarchical, machine-understandable and addressable format, including property/values and links to parent/child product types, and linked data. The definitions of the products and processes can then be utilized in a supporting framework, to enable distributed, decentralized implementations. When a step in the process has the data inputs it needs, the step executes. This data-driven approach, including the linked data, filters, and progressive formats, allows any given step in a process to be triggered by inputs coming from any other process step, provided the inputs pass the given step's input product filter, thereby enabling new process creation and new process behavior which is dynamic and autonomous. The focus of the DAPM is on the agile and dynamic representation of the processes, not on the execution engine; however, the design of the representation includes assumptions about the agile execution needs for dynamism, scalability, autonomy, and distributed functionality. For example, rather than have a process engine that “drives” the process according to some hardcoded process flow, the DAPM allows steps to proceed in whatever order as long as they have the needed inputs. This enables process steps to be skipped or for new processes to be inserted to drive existing processes, for parts of processes to be seamlessly reused by other processes, and for new processes to form automatically if the inputs and outputs for subprocesses match. This means that process steps can be skipped and inserted, that processes can self-integrate, and much greater reuse of processes and subprocesses is possible without hardwiring, recoding and without requiring costly, brittle, and unscalable orchestrated centralized control.

Implementation of method 10 through the use of the DAPM provides situational awareness to a computer because the DAPM has the ten characteristics derived from the definition of situational awareness discussed above. To illustrate, consider the first characteristic; (1) A “situation” is a set of facts . . . DAPM consists of a sequence of actions each of which is intended to produce a product and the collection of those products are a representation of the “facts”. For example, if a step in the process involves a transport of a unit to a given location, then the output “product” is the location of the unit, represented by a unit position report. If the goal of that step was met, then the position of the unit is at the goal location; however, whether the goal is met or not, the unit location is a fact. Other facts are represented by other products of our process or by other processes.

Next, consider the second characteristic: (2) . . . connected by some common aspect, e.g. person or location. A set of processes may have a common aspect, such as having the same operator or involving the same location. Other examples of the common aspect include, but are not limited to, a location, a time-range, a person, an organization, a field of study, a given topic, a user-entered property value, and a user-entered property value range. These processes having a common aspect, in the DAPM, can be found by searching the process repository for processes containing this common aspect, which is the basis for the intersection of the processes. For example, Person A's situation is the intersection of all ongoing processes where Person A is the operator. The car accident “situation”, discussed above, is the intersection of all the processes involving Person A's car, the other car, the occupants, the responders and the geographic area. One can focus this “situation” by looking at it from a given perspective. For example, if one considers the car accident from Person A's perspective, then one is looking at Person A's health and status. This perspective provides focus and filters the vast amount of information.

Next, consider the third characteristic: (3) . . . related to some goal or mission. There are many facts associated with a person or place, but for those facts to be of relevance for situation awareness, they must be related to a goal or mission. Process models are used to capture business processes for achieving specific goals and missions. So the use of process models for representing situational awareness is a natural fit in this regard. Built into the representation is the notion that the output products from each step in the process relate directly to a goal or mission.

Next, consider the fourth characteristic: (4) . . . of some significance, i.e. significantly impacts our ability to achieve the goal. Processes often include metrics to determine if the goal of the process is reached. Since processes are intended to accomplish a goal and a process model is a distillation of the most significant steps of the process, then the process model naturally contains products which are significant. So the use of processes to represent situational awareness offers direct linked connection between significant facts (products) and the process goal.

Next, consider the fifth characteristic: (5) Situation “Awareness” is the perception of these facts by an agent (a person or system). Awareness in the form of perception can be direct or indirect. For example, one can directly observe a car accident if one happens to be at that location at that time but most of the time one would gain awareness by being told about it. Just as with people, machine systems can “perceive” directly or indirectly. A video camera mounted on one of the vehicles or pressure sensors in the bumper may enable the machine to directly “perceive” the accident and the car may send a message to an emergency response computer which gains its form of awareness indirectly. If one has a machine representation of situation awareness which can be updated by a computer or human and shared with other computers or humans, then both direct and indirect perceptions are covered.

Next, consider the sixth characteristic: (6) . . . from a relevant perspective. The perspective could be a particular person's perspective, or a particular role, or a particular location, basically anything that allows an appropriate filtering of the massive amounts of data. The DAPM supports filtering on these elements. Then there is the seventh characteristic: (7) . . . with an understanding of the impact of those facts on future actions taken to achieve the goal. Simple awareness of facts as noted is often not enough; some assessment of the facts is needed to understand their impact on the goal. Since understanding the impact of current facts on future goals is never perfect, it might be better to think of this as the ability to try to represent probabilities or weights on the most likely outcomes given the current situation. With the DAPM, weights may be applied to the desired outcomes at each step, and process flow or lack of flow could be considered or predicted, and in this way, one can envision that a machine could begin to “consider” the impact of current facts on future actions and whether that impact is positive or negative relative to the goals of those processes. Although this may not be true “understanding” of situation awareness, it is a useful start.

Next, consider the eighth characteristic: (8) . . . represented as a mental model. A process can be one representation of the mental model of a person performing that process. The DAPM is a process model which can be understood by a person or stored, accessed, searched, and managed by a computer system. If one hopes to utilize computers effectively to assist humans with major tasks, rather than just use them as telecommunication devices, then it's important to have not just a mental model but also a corresponding machine-understandable model. Next is the ninth characteristic: (9) . . . useful for integrating diverse complex data streams into a simpler whole. The DAPM's organization of processes and products in a generic, hierarchical, iterative fashion lends itself to enabling the representation of complex systems from simpler component parts. The earlier discussion of the DAPM support for filters and perspectives also addresses in part this need to manage complex data.

Finally, consider the tenth characteristic: (10) . . . incorporating past (actions and goals), present (state of affairs) and (impact on) future (actions). If one is in the middle of a process, then the previous steps in the process represent the past and help to explain how one got here in terms of actions and goals. The current states of all the intersecting processes and their products represent the current state of affairs. And the future steps in the processes can be used to judge the impact of the current facts on the future.

Situational awareness has a fractal nature. One solution to generating and managing complexity in nature is to have a fractal design. A fractal is self-similar, which means that when one zooms in on a portion of the whole system, the portion resembles the whole system in structure. For example, a branch of a tree appears structurally similar to the whole tree. What are the advantages of a branching fractal design? Branching designs show up in biological systems, such as trees, roots, lungs, and arteries; however, they also appear in other areas of nature such as networks of rivers and streams. The problem solved by this branching is how to enable and balance the distribution or collection of resources (oxygen, nutrients, water) across a large surface area with the speed and volume of material distributed. So for example, this is how one distributes oxygen to every living cell in the body after breathing in one large breath of air. The lungs use a branching solution to create in the human chest an absorbing surface area that is as large as a tennis court. This solution for managing surface area and volume can help us address management challenges, such as situation awareness.

Situation awareness similarly involves filtering and aggregating each piece of knowledge (small volume) across the whole span of our mission (wide surface area) into an overall large piece of knowledge, i.e. an assessment (high volume) of what one should do next (low surface area). Humans naturally aggregate and branch information into a cognitively manageable set of a relatively few (e.g. 7) items at various levels. This branching resembles the fractal branching and offers the same advantages and enables the same simple pattern and self-similarity at each level. A good model of situational awareness exhibits the same type of branching, summarization and aggregation.

The DAPM has a fractal branching design. The DAPM enables branching through its use of URL links to child processes or parent processes. So each process step can be linked to a small number of substeps. This “progressive” organization of process steps, where the detail is progressively revealed as one traverses the process tree, enables DAPM to model the desired fractal branching design of situational awareness. Each step in a process, no matter the level, shows the same linking structure, thereby providing self-similarity. The DAPM enables aggregation by having its own data values at each level for assessment, including percent complete and mission impact. Each process step can have an assessment or decision as its input or output product and thereby distribute these assessments or decisions across the architecture. The products, in addition to the process steps, are organized by their types into a hierarchical generic structure, enabling aggregation and summarization. This infinite self-similarity can be modeled to any desired level with the DAPM.

Method 10 enables robots and avatars to gain a degree of self awareness/consciousness, enabling avatars to function with a machine-understandable representation of situational awareness. Method 10 makes it possible to represent, manage and share situational awareness across mixed reality applications (e.g., virtual, and augmented reality), including applications attempting to utilize smart avatars. Having a degree of situational awareness allows computers to make more informed decisions, thereby increasing overall computer performance. For example, method 10 may be used to create an improved training environment for large organizations in that method 10 enables a computer to represent multiple related/intersecting processes. A computer/machine implementing method 10 in a training environment will exhibit improved monitoring of progress and status during training and operations (since the machine stores specific output products for each step), increased flexibility for supporting innovative dynamic changes to the training (since steps in a process can be skipped or modified since the steps are indirectly linked by their products), improved reuse of process components (since generating an output product that matches an input filter can trigger automatic reuse of existing process components) and improved speed of automation (since process components are automatically linked and triggered via input/output products being posted to the cloud). These are significant improvements to computer monitoring, flexibility, reuse and speed of automation. An agile training network is disclosed in the paper “Fifty Steps to Agile Training: A Dynamic Process and Data Driven Approach to an Agile Training Framework” by Jeff Waters et al., which is attached hereto as Appendix I and is incorporated by reference herein.

Method 10 enables an autonomous robot and/or computer-controlled avatar to make situational assessments such as, but not limited to, identification of remaining steps, identification of obstacles to executing the remaining steps, a time estimate for completion of the remaining steps, and a probability that the goals will be reached by a certain time. This situational assessment may then be reported to a human and/or to serve as inputs to future decisions.

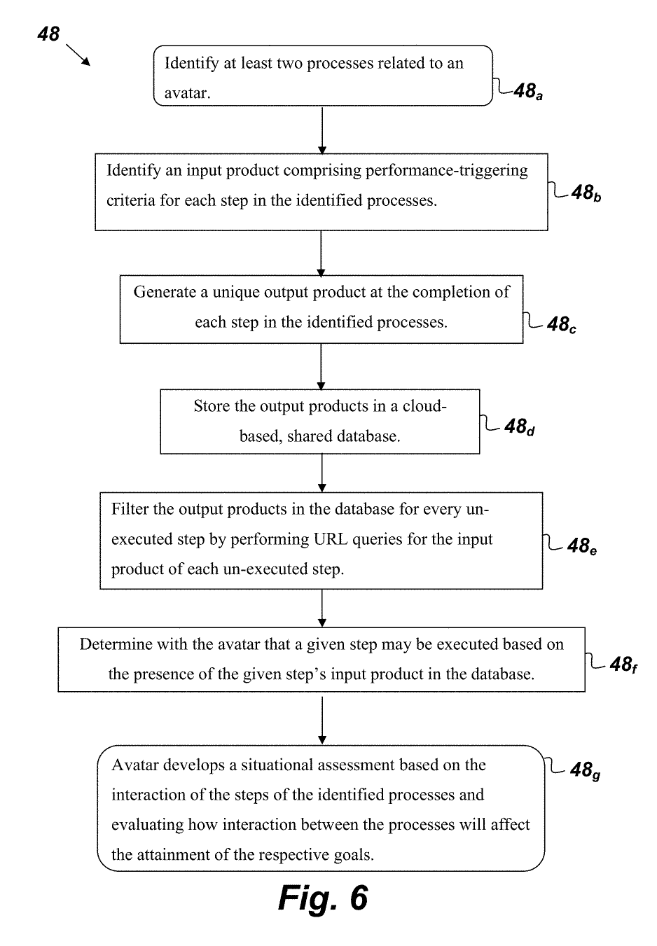

FIG. 6 is a flowchart of a method 48 that uses the principles of method 10 to provide situational awareness to an avatar in a simulated environment. The first step 48ₐ provides for identifying at least two processes related to the avatar. As discussed above, each process comprises a series of steps and an end goal. The next step 48_{b} provides for identifying an input product comprising performance-triggering criteria for each step in the identified processes. The next step 48_{c} provides for generating a unique output product at the completion of each step in the identified processes. The next step 48_{d} provides for storing the output products in a cloud-based, shared database. Each output product and each input product has a unique URL according to a taxonomy. The next step 48ₑ provides for filtering the output products in the database for every un-executed step by performing URL queries for the input product of each un-executed step. The next step 48_{f} provides for determining with the avatar that a given step may be executed based on the presence of the given step's input product in the database. The next step 48_{g} provides for developing with the avatar a situational assessment based on the interaction of the steps of the identified processes and evaluating how interaction between the processes will affect the attainment of the respective goals. The situational assessment may be reported to a human and the avatar may be configured to periodically update the situational assessment as further information is available. The avatar may further be configured to alter its behavior in view of the situational assessment.

From the above description of the method 10 for providing situational awareness to a computer, it is manifest that various techniques may be used for implementing the concepts of method 10 without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that method 10 is not limited to the particular embodiments described herein, but is capable of many embodiments without departing from the scope of the claims.

We claim:

1. A computer implemented method comprising:
inputting steps of at least two processes into the computer, wherein each step corresponds to a set of input products, a task to be completed, a set of output products, and a set of target output products, and wherein each input product, each output product, each target output product, and each task, comprises a set of property/value pairs that includes product type and product target values, where the properties have unique URL-based names and the property relationships are supported by an underlying ontology including a hierarchical taxonomy of product types, and where the target products specify a desired range for each corresponding property value;
storing each input product and each output product in a shared, non-transitory database as they are generated, wherein each input product and each output product is stored with a unique uniform resource locator (URL);
establishing an input product filter for each step, wherein the input product filter comprises performance-triggering criteria defined property/value filters, where one step's output product passes the input product filter of another step;
periodically searching the shared database with URL queries for input products;
determining with the computer whether each step in any of the processes has been executed, is in the process of being executed, or is awaiting execution;
dynamically and automatically assembling or altering a set of steps composing any given process depending on the input products available in the shared database; and
comparing with a performance status monitoring engine the input/output products property values to the target property values to automatically assess the status, effectiveness and efficiency of the individual steps and of each process as a whole.

2. The method of claim 1, wherein a given step is deemed executed if all of the given step's input products are found in the shared database and all the given step's output products have been generated and stored in the shared database, wherein the given step is awaiting execution if all of the given step's input products are found in the shared database but not all of the given step's output products have been generated, and wherein the given step is awaiting execution if all of the given step's input products are not found in the shared database.

3. The method of claim 2, where the URLs are defined according to Representational State Transfer (REST) design principles.

4. A method for providing situational awareness to a computer comprising:
identifying a first process and a second process that have an aspect in common, wherein each of the first and second processes comprises a series of steps and an end goal;
identifying an input product comprising performance-triggering criteria for each step in the first and second processes;
generating a unique output product at the completion of each step in the first and second processes;
storing the output products in a cloud-based, shared database, wherein each output product and each input product has a unique uniform resource locator (URL) according to a taxonomy;
filtering with the computer the output products in the database for every un-executed step by performing URL queries for the input product of each un-executed step;
determining that a given step may be executed based on the presence of the given step's input product in the database; and
determining with the computer a situational assessment based on the interaction of the steps of the first and second processes and evaluating how interaction between the two processes will affect the attainment of the goals.

5. The method of claim 4 wherein, each product is represented as a set of property/value pairs where the properties have unique URL-based names and the property relationships are supported by an underlying ontology including a hierarchical taxonomy of product types.

6. The method of claim 4, wherein output products are defined in a progressive, generic, hierarchical, machine-understandable, and addressable format.

7. The method of claim 6, wherein the progressive, generic, hierarchical, machine-understandable, and addressable format is JavaScript Object Notation for Linked Data (JSON-LD).

8. The method of claim 7, wherein the output products include property values.

9. The method of claim 8, wherein the output products link to parent/child product types and linked data.

10. The method of claim 4, wherein the common aspect is an aspect or a combination of aspects selected from the group consisting of: a location, a time-range, a person, an organization, a field of study, a given topic, a user-entered property value, and a user-entered property value range.

11. The method of claim 4, wherein the situational assessment further includes an identification of remaining steps, identification of obstacles to executing the remaining steps, a time estimate for completion of the remaining steps, and a probability that the goals will be reached by a certain time.

12. The method of claim 4, further comprising the step of reporting the situational assessment to a user.

13. The method of claim 4, further comprising the step of eliminating a step from the first process based on the situational assessment.

14. The method of claim 4, wherein the first and second processes are tasks performed by the computer.

15. A method for providing situational awareness to a computer-controlled avatar in a simulated environment;
identifying at least two processes related to the avatar, wherein each process comprises a series of steps and an end goal;
identifying an input product comprising performance-triggering criteria for each step in the identified processes;
generating a unique output product at the completion of each step in the identified processes;
storing the output products in a cloud-based, shared database, wherein each output product and each input product has a unique uniform resource locator (URL) according to a taxonomy;
filtering the output products in the database for every un-executed step by performing URL queries for the input product of each un-executed step;
determining with the avatar that a given step may be executed based on the presence of the given step's input product in the database; and
developing with the avatar a situational assessment based on the interaction of the steps of the identified processes and evaluating how interaction between the processes will affect the attainment of the respective goals.

16. The method of claim 15 further comprising the step of reporting the situational assessment to a human.

17. The method of claim 15, further comprising the step of having the avatar periodically updating the situational assessment as further information is available.

18. The method of claim 15, further comprising the step of having the avatar alter its behavior in view of the situational assessment.
